(19) United States
(12) Patent Application Publication
(10) Pub. No.: US 2019/0129807 A1
(43) Pub. Date: May 2, 2019

(54) METHOD AND DEVICE FOR MANAGING A VIRTUAL MACHINE

(71) Applicant: EMC IP Holding Company, Hopkinton, MA (US)

(72) Inventor: Yun Zhang, Shanghai (CN)

(21) Appl. No.: 16/166,515

(22) Filed: Oct. 22, 2018

(30) Foreign Application Priority Data
Oct. 27, 2017 (CN) 201711024356.9

(51) Int. Cl. G06F 11/14; G06F 9/455

(52) U.S. Cl. CPC G06F 11/1458; G06F 2009/45562; G06F 9/45558

(57) ABSTRACT

Embodiments of the present disclosure relate to a method and device for managing a virtual machine. The method comprises: determining, based on an attribute of the virtual machine, a virtual machine client corresponding to the virtual machine, the virtual machine client being characteristic information of the virtual machine in a backup system; and determining, based on the virtual machine client, a backup policy for the virtual machine to back up the virtual machine, the backup policy indicating a manner of backing up the virtual machine in the backup system.

### RELATED APPLICATIONS

This application claim priority from Chinese Patent Application Number CN 201711024356.9, filed on Oct. 27, 2017 at the State Intellectual Property Office, China, titled “METHOD, APPARATUS, AND COMPUTER PROGRAM PRODUCT FOR MANAGING VIRTUAL MACHINE” the contents of which is herein incorporated by reference in its entirety.

### FIELD

Embodiments of the present disclosure generally relate to virtual machine management, and more specifically, to a method and device for backing up virtual machines.

### BACKGROUND

A data center includes virtual machines for running workloads for various businesses. Since the workloads or businesses will be added, deleted or updated, a backup administrator needs to set backup policies for the workloads or businesses, for example, set different backup policies for workloads for different businesses. Hence, it is desirable to provide an improved solution for improving virtual machine backup performance.

### SUMMARY

Embodiments of the present disclosure provide a method and device for managing a virtual machine.

According to a first aspect of the present disclosure, there is provided a method of managing a virtual machine. The method comprises: determining, based on an attribute of the virtual machine, a virtual machine client corresponding to the virtual machine, the virtual machine client being characteristic information of the virtual machine in a backup system; and determining, based on the virtual machine client, a backup policy for the virtual machine to back up the virtual machine, the backup policy indicating a manner of backing up the virtual machine in the backup system.

According to a second aspect of the present disclosure, there is provided a device for managing a virtual machine. The device comprises: at least one processing unit and at least one memory. The at least one memory is coupled to the at least one processing unit and stores instructions to be executed by the at least one processing unit. The instructions, when executed by the at least one processing unit, cause the device to perform acts comprising: determining, based on an attribute of the virtual machine, a virtual machine client corresponding to the virtual machine, the virtual machine client being characteristic information of the virtual machine in a backup system; and determining, based on the virtual machine client, a backup policy for the virtual machine to back up the virtual machine, the backup policy indicating a manner of backing up the virtual machine in the backup system.

According to a third aspect of the present disclosure, there is provided a computer program product that is tangibly stored on a non-transitory computer readable medium and includes machine-executable instructions. The machine-executable instructions, when executed, cause a machine to perform steps of the method described according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following more detailed description of the example embodiments of the present disclosure with reference to the accompanying drawings, the above and other objectives, features, and advantages of the present disclosure will become more apparent. In example embodiments of the present disclosure, the same reference signs usually represent the same components.

FIG. 1 illustrates a schematic diagram of a virtual machine management system according to an embodiment of the present disclosure;

FIG. 2 illustrates a flow chart of a method of managing virtual machines according to an embodiment of the present disclosure; and

FIG. 3 illustrates a schematic block diagram of an example device that can be used to implement embodiments of the present disclosure.

Throughout the drawings, the same or corresponding reference signs refer to the same or corresponding parts.

### DETAILED DESCRIPTION OF EMBODIMENTS

Preferred embodiments of the present disclosure will be described in the following in greater detail with reference to the drawings. Although the preferred embodiments of the present disclosure are displayed in the drawings, it is to be understood that the present disclosure may be implemented in various manners, and should not be limited to the embodiments illustrated herein. On the contrary, these embodiments are provided to make the present disclosure more thorough and complete and fully convey the scope of the present disclosure to those skilled in the art.

As used herein, the term “include” and its variants are to be read as open-ended terms that mean “include, but is not limited to.” The term “or” is to be read as “and/or” unless the context clearly indicates otherwise. The term “based on” is to be read as “based at least in part on.” The terms “an example embodiment” and “an embodiment” are to be read as “at least one example embodiment.” The term “another embodiment” is to be read as “at least one further embodiment.” The terms “first” and “second” can represent different or same objects. The following text may also include other explicit and implicit definitions.

Traditionally, in order to backup a virtual machine, a user needs to manually assign a backup policy to the virtual machine, and manually update the backup policy when the workload or business of the virtual machine changes. However, when the data center includes a large number of virtual machines, it is difficult to perform the above manual operation, and manual operation is error-prone as well. In addition, in the case of manually assigning and updating the backup policy for the virtual machine, the user needs to wait for the assignment and update to complete, thereby wasting the user's time.

To this end, the backup administrator may create in the backup system a container for the plurality of virtual machines. When the container is backed up, the plurality of virtual machines related to the container are backed up. However, the container (for example, a folder) needs to be well organized with respect to the virtual machines, thus such backup manner depends on how the backup administrator organizes a virtual environment. In addition, in the case that the virtual environment does not support the container, the container cannot be used for backup. Hence, it is impossible to solve problems that the manual operation is difficult to perform and error-prone, and thereby failing to improve efficiency and robustness of the backup system.

To at least partially solve the above problems and one or more of other potential problems, example embodiments of the present disclosure provide a solution for managing virtual machines. In the solution, a virtual machine client corresponding to a virtual machine is automatically added, updated and deleted in the backup system, and a backup policy for the virtual machine is automatically determined based on the virtual machine client. In this way, the efficiency and robustness of the backup system can be improved in a concise and effective manner, and thereby improving the user's experience.

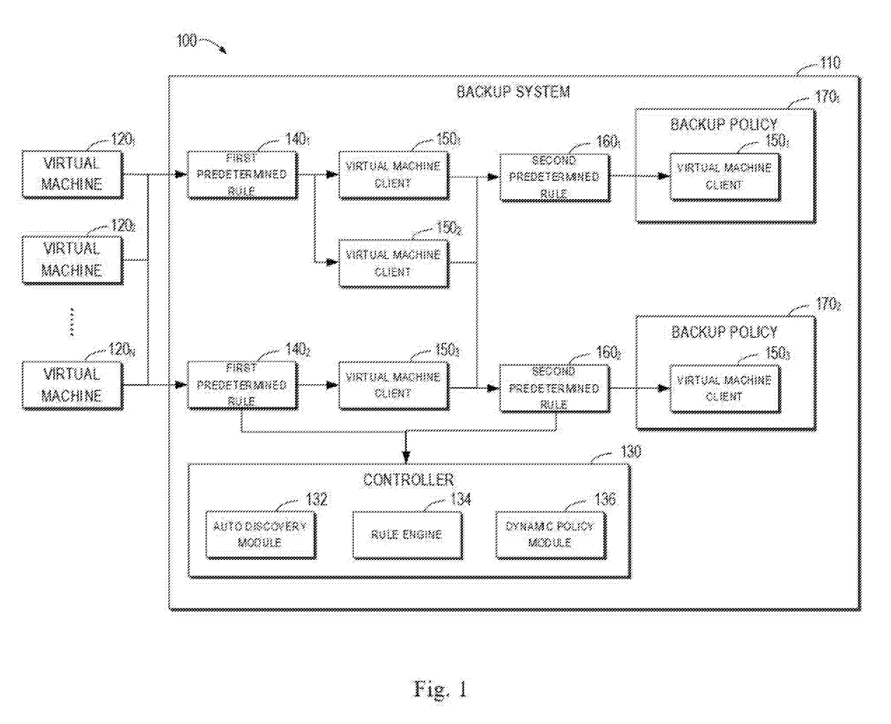

FIG. 1 illustrates a schematic diagram of a virtual machine management system 100 according to an embodiment of the present disclosure. It should be appreciated that the virtual machine management system 100 as shown in FIG. 1 is only used for example purpose, and does not suggest any limitations to the scope of the present disclosure. Embodiments of the present disclosure may be embodied in different structures.

As shown in FIG. 1, the virtual machine management system 100 includes a backup system 110 and a group of virtual machines 120₁-120_{N} (hereinafter collectively referred to as virtual machine 120), wherein N is a natural number larger than or equal to 1. As stated above, the virtual machine 120 is used to run workloads for various businesses.

The backup system 110 may include backup policies 170₁ and 170₂ (hereinafter referred to as backup policy 170). The backup policy 170 specifies a manner of backing up the virtual machine 120 in the backup system 110. In some embodiments, the backup policy 170 may be a logic group defining when to back up the virtual machine 120, where to back up the virtual machine 120, which portions of the virtual machine 120 are backed up, and how long the backup of the virtual machine 120 is retained.

To automatically add, update and delete the virtual machine 120 in the backup system 110, and determine the backup policy for the virtual machine 120, the backup system 110 is configured with a controller 130. The controller 130 may determine, based on attributes of the virtual machine 120, a virtual machine client corresponding to the virtual machine 120, and determine the backup policy for the virtual machine 120 based on the virtual machine client.

In the text, virtual machine clients 150₁-150₃ (hereinafter referred to as virtual machine client 150) may be characteristic information of the virtual machine 120 in the backup system 110. The characteristic information may be used to identify the virtual machine 120.

Attributes of the virtual machine 120 may be for example a name, an access path, a virtual application name, a resource pool, a data center path, a data store name, a data store cluster name, and a tag. The name may be a name of the virtual machine 120. The access path may be a path where the virtual machine 120 is located. The virtual machine application may be regarded as a group of virtual machines 120, thus the virtual machine application name may be a name of the group of virtual machines 120. The resource pool may be a location where the virtual machine 120 shares its computing resource. The data center path may be a path of the data center where the virtual machine 120 exists. The data store name may be a name of a data store where a storage of the virtual machine 102 locates. The data store cluster name may be a name of a data store cluster where a storage of the virtual machine 102 locates. The tag may be any key-value pair for describing the virtual machine 120. For example, a tag “Tag=[System. Windows]” may be set for the virtual machine 120. The tag indicates that the type of the tag is “System” and the value of the tag is “Windows”.

It should be appreciated that the above-discussed attributes of the virtual machine 120 are illustrative and not restrictive, without suggesting any limitations to the scope of the present disclosure.

In some embodiments, the controller 130 may include an auto discovery module 132, a rule engine 134 and a dynamic policy module 136. The auto discovery module 132 may automatically selects the virtual machine 120, and add the virtual machine client 150 corresponding to the selected virtual machine 120 into the backup system 110. The rule engine 134 may use rules to evaluate the virtual machine 120 and/or virtual machine client 150 to select the virtual machine 120 and/or virtual machine client 150 which satisfies the rules. The dynamic policy module 136 may automatically and dynamically assign the backup policy to the virtual machine client 150.

Specifically, in some embodiments, to determine the virtual machine client 150 corresponding to the virtual machine 120, the auto discovery module 132 may obtain attributes of the virtual machine 120. For example, the auto discovery module 132 may obtain the attributes of the virtual machine 120 from the virtual machine 120. Alternatively, the backup system 110 may store the attributes of the virtual machine 120. In this case, the auto discovery module 132 may obtain the attributes of the virtual machine 120 from the backup system 110.

In addition, in some embodiments, the auto discovery module 132 may obtain attributes of all virtual machines 120₁-120_{N}. Alternatively, in the case that the attributes of a certain virtual machine 120 change, the auto discovery module 132 may obtain the changed attributes of the virtual machine 120. Alternatively, in the case that a new virtual machine 120 is added into the virtual machine management system 100, the auto discovery module 132 may obtain attributes of the new virtual machine 120. In some embodiments, the virtual machine 120 may notify the auto discovery module 132 of the change in the attributes of the virtual machine 120 by a virtual machine change event, or notify the auto discovery module 132 that a new virtual machine 120 has been added by a virtual machine adding event. Alternatively, the backup system 110 may notify the auto discovery module 132 by a virtual machine change/adding event. In this manner, it is possible to ensure that the virtual machine client 150 in the backup system 110 is updated in real time.

Then, the auto discovery module 132 may provide the obtained attributes of the virtual machine 120 to the rule engine 134. The backup system 110 may include first predetermined rules 140₁ and 140₂ (hereinafter referred to as first predetermined rule 140). The rule engine 134 may obtain and use the first predetermined rule 140 to evaluate the virtual machine 120, to determine the virtual machine client 150 corresponding to the virtual machine 120. For clarity purpose, FIG. 1 only shows first predetermined rules 140₁ and 140₂, and it should be appreciated that the number of the first predetermined rule 140 is not restricted.

For example, as shown in FIG. 1, the rule engine 134 may obtain the first predetermined rule 140₁, and determine that attributes of the virtual machines 120₁ and 120₂ satisfy the first predetermined rule 140₁. In addition, the rule engine 134 may further obtain the first predetermined rule 140₂, and determine that attributes of the virtual machine 1201_{N} satisfy the first predetermined rule 140₂.

The first predetermined rule 140 is a generalized rule associated with the attributes of the virtual machine 120. The first predetermined rule 140 may be for example a rule created by the user or defined by the system, or be implemented in any proper format. For example, in some embodiments, the first predetermined rule 140 may include an executable code written in any proper programming language and/or script language. Alternatively, the first predetermined rule 140 may be described with a formatted text such as an extensible markup language (XML) text or a plaintext.

In some embodiments, the first predetermined rule 140 may be a basic rule “Tag[System] contains Windows”. In addition, the first predetermined rule 140 may be a compound rule obtained by combining basic rules. For example, logic operation such as “AND”, “OR” and “NOT” can be performed on the basic rules to obtain the compound rule. As an example, the first predetermined rule 140 may be the compound rule “Tag[System] contains Windows AND Tag[App] contains SQL”. In addition, the first predetermined rule 140 may be a compound rule obtained by combining compound rules.

The rule engine 134 may obtain the first predetermined rule 140 according to the demand or attributes of the virtual machine. For example, to obtain the first predetermined rule 140, the rule engine 134 may determine, from a set of predetermined rules, a subset related to the attributes of the virtual machine 120, and select the first predetermined rule 140 from the subset. For example, the rule engine 134 may determine, from the entire set of the predetermined rules, a subset related to the system of the virtual machine 120, for example, “Tag[System] contains Windows” and “Tag[System] contains Linux”. Then, the rule engine 134 may select the first predetermined rule 140 “Tag[System] contains Windows” from the subset.

The rule engine 134 is usually a logic engine. In some embodiments, to use the first predetermine rule 140 to evaluate the virtual machine 120, the rule engine 134 may determine whether the attributes of the virtual machine 120 satisfy the first predetermined rule 140. For example, the rule engine 134 may make some basic determinations on the attributes of the virtual machine 120 based on the basic rules. For example, if the attribute of the virtual machine 120 is of a string type, the rule engine 134 may determine whether the attribute is equal to a predetermined value, is started with a predetermined value, is ended with a predetermined value, includes a predetermined value, and matches a predetermined regular expression. If the attribute of the virtual machine 120 is of a numerical type, the rule engine 134 may determine whether the attribute is equal to a predetermined value, larger than a predetermined value or smaller than a predetermined value. In addition, if the attribute of the virtual machine 120 is of a container type (for example, an array or list structure), the rule engine 134 may determine whether the attribute includes a predetermined value.

As an example, the virtual machine 120 may have an attribute “Tag=[System.Windows]”, the first predetermined rule 140 may be “Tag[System] contains Windows”. In this case, the rule engine 134 may determine that the attribute of the virtual machine 120 satisfies the first predetermined rule 140.

In addition, in the case that the first predetermined rule 140 is a compound rule, the rule engine 134 may combine the basic determinations to obtain a compound determination. For example, the rule engine 134 may perform logic operations such as “AND”, “OR” and “NOT” on the basic determinations to obtain a compound determination. As an example, the virtual machine 120 may have an attribute “Tag=[System.Windows, App.SQL]”, and the first predetermined rule 140 may be “Tag[System] contains Windows AND Tag[App] contains SQL”. In this case, the rule engine 134 may perform an “AND” operation on the basic determinations for the basic rules “Tag[System] contains Windows” and “Tag[App] contains SQL”. In this example, the rule engine 134 may determine that the attributes of the virtual machine 120 satisfies the first predetermined rule 140. In addition, the rule engine 134 may also combine compound determinations to obtain a compound determination.

The rule engine 134 may return the attributes of the virtual machine 120 satisfying the first predetermined rule 140 to the auto discovery module 132. The auto discovery module 132 may determine the virtual machine client 150 based on the returned attributes of the virtual machine 120. For example, as shown in FIG. 1, in the case that the first predetermined rule 140₁ is used, the rule engine 134 may return the attributes of the virtual machines 120₁ and 120₂, so that the auto discovery module 132 may create the virtual machine clients 150₁ and 150₂ corresponding to the virtual machines 120₁ and 120₂, respectively. In addition, in the case that the first predetermined rule 140₂ is used, the rule engine 134 may further return the attribute of the virtual machine 120_{N}, so that the auto discovery module 132 may create the virtual machine client 150₃ corresponding to the virtual machine 120_{N}.

In some embodiments, the auto discovery module 132 may include the attributes of the virtual machine 120 in the virtual machine client 150. For example, the auto discovery module 132 may include the name of the virtual machine 120 in the virtual machine client 150.

In addition, in some embodiments, to determine the backup policy for the virtual machine 120 based on the virtual machine client 150, the dynamic policy module 136 may obtain the attributes of the virtual machine 120 based on the virtual machine client 150. For example, the dynamic policy module 136 may obtain the attributes of the virtual machine 120 from the virtual machine client 150. Alternatively, as stated above, since the virtual machine client 150 may identify the virtual machine, the dynamic policy module 136 may obtain, based on the virtual machine client 150, the attributes of the virtual machine 120 stored in the backup system 110.

In some embodiments, the dynamic policy module 136 may obtain the attributes of the virtual machine 120 when the backup policy 170 is triggered. For example, the backup policy may specify that the virtual machine 120 should be backed up at 0 o'clock every day. In this case, the backup system 110 may trigger the backup policy 170 at 0 o'clock every day, and notify, through the trigger event, the dynamic policy module 136 that the backup policy is triggered. The dynamic policy module 136 may obtain the attributes of the virtual machine 120 upon receiving the trigger event. In this manner, the backup policy for the virtual machine 120 can be determined in real time when the virtual machine 120 needs to be backed up, thereby ensuring performing backup for the virtual machine 120 that currently satisfies the predetermined rule.

In addition, the dynamic policy module 136 may further obtain the attributes of the virtual machine 120 directly from the virtual machine 120 based on the virtual machine client 150. In some embodiments, the dynamic policy module 136 may obtain the attributes of the virtual machine 120 when the virtual machine client 150 is updated or a new virtual machine client 150 is created. In this manner, it is possible to ensure that the backup policy 170 for the virtual machine 120/virtual machine client 150 can be determined based on the updated virtual machine client 150.

Then, the dynamic policy module 136 may provide the obtained attributes of the virtual machine 120 to the rule engine 134. The backup system 110 may include second predetermined rules 160₁ and 160₂ (hereinafter referred to as second predetermined rule 160). The rule engine 134 may obtain and use the second predetermined rule 160 to evaluate the virtual machine client 150 to determine the backup policy 170 for the virtual machine 120/virtual machine client 150. For the sake of clarity, FIG. 1 only shows the second predetermined rules 160₁ and 160₂, and it should be appreciated that the number of the second predetermined rule 160 is not restricted.

For example, as shown in FIG. 1, the rule engine 134 may obtain the second predetermined rule 160₁, and determine that attributes of the virtual machine 120₁ corresponding to the virtual machine client 150₁ satisfy the second predetermined rule 160₁. In addition, the rule engine 134 may further obtain the second predetermined rule 160₂, and determine that attributes of the virtual machine 1201_{N} corresponding to the virtual machine client 150₃ satisfy the second predetermined rule 160₂.

Like the first predetermined rule 140, the second predetermined rule 160 is a generalized rule associated with the attributes of the virtual machine 120. For example, the second predetermined rule 160 may be a basic rule or a compound rule. The rule engine 134 may obtain the second predetermined rule 160 based on demand or the attributes of the virtual machine. Since the first predetermined rule 140 has been described in detail in the above text, description of the second predetermined rule 160 is omitted herein.

In some embodiments, similar to using the first predetermined rule 140 to evaluate the virtual machine 120, to use the second predetermined rule 160 to evaluate the virtual machine 120, the rule engine 134 may determine whether the attributes of the virtual machine 120 satisfy the second predetermined rule 160. For example, the rule engine 134 may make some basic determinations on the attributes of the virtual machine 120 based on the basic rule. In addition, in the case that the second predetermined rule 160 is a compound rule, the rule engine 134 may combine the basic determinations to obtain a compound determination. Since the above text has already described in detail a manner of the rule engine 134 using the first predetermined rule 140 to evaluate the virtual machine 120, description of the rule engine 134 using the second predetermined rule 160 to evaluate the virtual machine 120 is omitted herein.

The rule engine 134 may return the attributes of the virtual machine 120 satisfying the second predetermined rule 160 to the dynamic policy module 160. The dynamic policy module 136 may determine, based on the returned attributes of the virtual machine 120, the backup policy for the virtual machine 120/virtual machine client 150. For example, as shown in FIG. 1, in the case that the second predetermined rule 160₁ is used, the rule engine 134 may return the attributes of the virtual machine 120₁, so that the dynamic policy module 136 may assign the backup policy 170₁ to the virtual machine 120₁/the virtual machine client 150₁ corresponding to the virtual machine 120₁. In addition, in the case that the second predetermined rule 160₂ is used, the rule engine 134 may return the attributes of the virtual machine 120_{N}, so that the dynamic policy module 136 may assign the backup policy 170₂ to the virtual machine 120_{N}/the virtual machine client 150₃ corresponding to the virtual machine 120_{N}.

In some embodiments, the dynamic policy module 136 may add the virtual machine client 150 in a to-backup list of the backup policy 170. For example, the dynamic policy module 136 may add the virtual machine client 150₁ into a backup list of the backup policy 170₁. The dynamic policy module 136 may add the virtual machine client 150₃ into a backup list of the backup policy 170₂. In this manner, the backup system 110 may associate the virtual machine 120/virtual machine client 150 with the backup policy 170, thereby backing up the virtual machine 120 based on the backup policy.

Through the above description, in the embodiment of the present disclosure, the virtual machine client 150 corresponding to virtual machine 120 can be automatically added, updated and deleted in the backup system 110, and the backup policy for the virtual machine 120 can be determined based on the virtual machine client 150. In this way, the burden for the user to manually assign and update the backup policy to the virtual machine 120 is eliminated, and the error rate of the backup system 110 is substantially reduced. Hence, the solution of managing the virtual machine 120 in the present disclosure improves availability and performance of the backup system 110.

In addition, to ensure that the backup policy 170 for the virtual machine 120/virtual machine client 150 is determined based on the attributes of the latest virtual machine 120, in some embodiments, in the case that a new virtual machine 120 is added, the auto discovery module 132 may obtain the attributes of the new virtual machine 120, so that the rule engine 134 and dynamic policy module 136 may determine the virtual machine client 150 corresponding to the new virtual machine 120 based on the attributes of the new virtual machine 120.

Furthermore, in the case that a new virtual machine client 150 is added, the dynamic policy module 136 may obtain the attributes of the virtual machine 120 based on the virtual machine client 150, and the rule engine 134 may determine whether the attributes of the virtual machine 120 satisfy the second predetermined rule 160 associated with the backup policy 170 for the virtual machine client 150. In the case that the attributes of the virtual machine 120 satisfy the second predetermined rule 160, the dynamic policy module 136 may determine the backup policy 170 for the virtual machine 120.

In some embodiments, when the attributes of the virtual machine 120 changes, the auto discovery module 132 may obtain the changed attributes of the virtual machine 120, so that the rule engine 134 and the dynamic policy module 136 may update the virtual machine client 150 based on the changed attributes of the virtual machine 120.

Furthermore, in the case that the virtual machine client 150 is updated, the dynamic policy module 136 may obtain the attributes of the virtual machine 120 based on the virtual machine client 150, and the rule engine 134 may determine whether the attributes of the virtual machine 120 satisfy the second predetermined rule 160 associated with the backup policy 170 for the virtual machine client 150. In the case that the attributes of the virtual machine 120 satisfy the second predetermined rule 160, the dynamic policy module 136 may determine the backup policy 170 for the virtual machine 120.

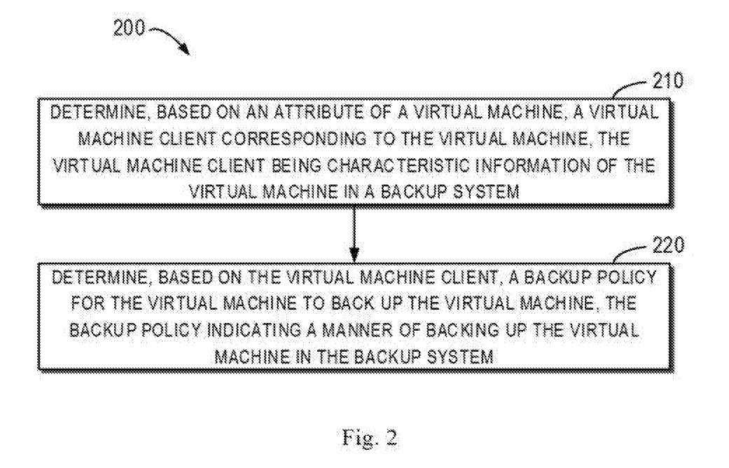

FIG. 2 illustrates a flow chart of a method 200 of managing virtual machines according to an embodiment of the present disclosure. For example, the method 200 may be performed by the controller 130 as shown in FIG. 1 or other proper device. It should be appreciated that the method 200 may further include additional steps not shown and/or the shown steps may be omitted. The scope of the present disclosure is not limited in this regard.

At 210, the controller 130 determines the virtual machine client 150 corresponding to the virtual machine 120 based on the attributes of the virtual machine 120. The virtual machine client 150 is characteristic information of the virtual machine 120 in the backup system 110. The attributes of the virtual machine 120 may include a name, an access path, a virtual application name, a resource pool, a data center path, a data store name, a data store cluster name, a tag and/or other related attributes.

In some embodiments, to determine the virtual machine client 150 corresponding to the virtual machine 120, the controller 130 obtains the first predetermined rule 140 associated with the attributes of the virtual machine 120. For example, the controller may determine, from a set of predetermined rules, a subset related to the attributes of the virtual machine 120, and select the first predetermined rule 140 from the subset. In the case that the attributes of the virtual machine 120 satisfy the first predetermined rule 140, the controller 130 may determine the virtual machine client 150 based on the attributes of the virtual machine 120. For example, the controller 130 may include the attributes of the virtual machine 120 in the virtual machine client 150.

At 220, the controller 130 determines the backup policy 170 for the virtual machine 120 based on the virtual machine client 150. The backup policy 170 specifies a manner of backing up the virtual machine 120 in the backup system 110. In some embodiments, to determine the backup policy 170 for the virtual machine 120, the controller 130 may obtain attributes of the virtual machine 120 based on the virtual machine client 150, and obtain the second predetermined rule 160 associated with the predetermined backup policy. In the case that the attributes of the virtual machine 120 satisfy the second predetermined rule 160, the controller 130 determines the predetermined backup policy to be the backup policy 170 for the virtual machine client 150.

In addition, in 220, to ensure that the backup policy 170 for the virtual machine 120/virtual machine client 150 is determined based on the current attributes of the virtual machine 120, in some embodiments, in the case that a new virtual machine 120 is added, the controller 130 may obtain the attributes of the new virtual machine 120, and determine the virtual machine client 150 corresponding to the new virtual machine 120 based on the attributes of the new virtual machine 12.

Furthermore, in the case that the new virtual machine client 150 is added, the controller 130 may obtain the attributes of the virtual machine 120 based on the virtual machine client 150, and determine whether the attributes of the virtual machine 120 satisfy the second predetermined rule 160 associated with the backup policy 170 for the virtual machine client 150. In the case that the attributes of the virtual machine 120 satisfy the second predetermined rule 160, the controller 130 may determine the backup policy 170 for the virtual machine 120.

In some embodiments, when the attributes of the virtual machine 120 is changed, the controller 130 may obtain the changed attributes of the virtual machine 120, and update the virtual machine client 150 based on the changed attributes of the virtual machine 120.

Furthermore, in the case that the virtual machine client 150 is updated, the controller 130 may obtain the attributes of the virtual machine 120 based on the virtual machine client 150, and determine whether the attributes of the virtual machine 120 satisfy the second predetermined rule 160 associated with the backup policy 170 for the virtual machine client 150. In the case that the attributes of the virtual machine 120 satisfy the second predetermined rule 160, the controller 130 may determine the backup policy 170 for the virtual machine 120.

Through the above description, in the embodiment of the present disclosure, the virtual machine client 150 corresponding to virtual machine 120 are automatically added, updated and deleted in the backup system 110, and the backup policy for the virtual machine 120 is determined based on the virtual machine client 150. In this way, the burden for the user in manually assigning and updating the backup policy to the virtual machine is eliminated, and the error rate of the backup system 110 is substantially reduced. Hence, the solution of managing the virtual machine 120 in the present disclosure improves availability and performance of the backup system 110.

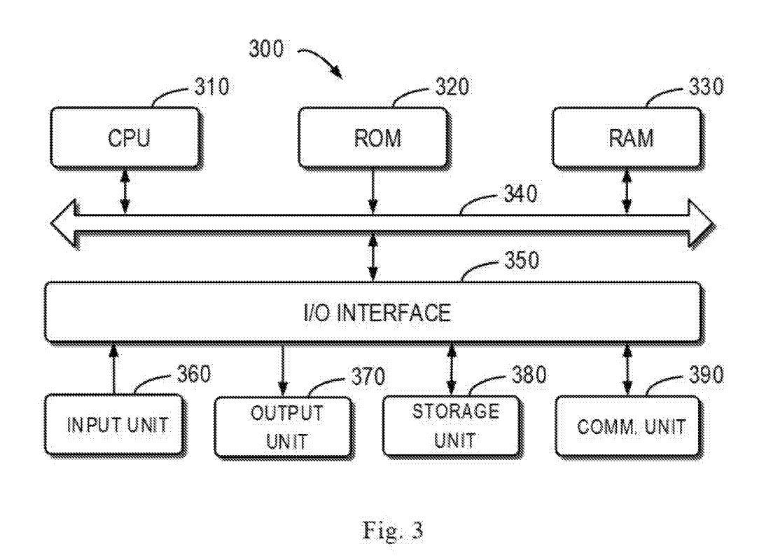

FIG. 3 illustrates a schematic diagram of an example device 300 for implementing embodiments of the present disclosure. For example, the controller 130 shown in FIG. 1 can be implemented by the device 300. As shown, the device 300 includes a central processing unit (CPU) 310, which can perform various appropriate acts and processing based on the computer program instructions stored in a read-only memory (ROM) 320 or the computer program instructions loaded into a random-access memory (RAM) 330 from a storage unit 380. The RAM 330 can also store various programs and data required for the operation of the device 300. The CPU 310, the ROM 320 and the RAM 330 are connected to each other via a bus 340. An input/output (I/O) interface 350 is also connected to the bus 340.

A plurality of components in the device 300 are connected to the I/O interface 350, including: an input unit 360, such as a keyboard, a mouse and the like; an output unit 370, such as various kinds of displays and loudspeakers and the like; the storage unit 380, such as a magnetic disk and an optical disk and the like; and a communication unit 390, such as a network card, a modem, a wireless transceiver and the like. The communication unit 390 allows the device 300 to exchange information/data with other devices via the computer network, such as the Internet, and/or various telecommunication networks.

The above described procedures and processing, such as the method 200, can also be performed by the processing unit 310. For example, in some embodiments, the method 200 can be implemented as a computer software program tangibly included in the machine-readable medium, for example, the storage unit 380. In some embodiments, the computer program can be partially or fully loaded and/or mounted to the device 300 via the ROM 320 and/or the communication unit 390. When the computer program is loaded onto RAM 330 and executed by the CPU 310, one or more acts of the above described method 200 can be implemented.

The present disclosure can be a method, apparatus, system and/or computer program product. The computer program product can include a computer readable storage medium, on which the computer readable program instructions for performing various aspects of the present disclosure are loaded.

The computer readable storage medium can be a tangible device that maintains and stores instructions utilized by the instruction executing device. For example, the computer readable storage medium can be, but not limited to, an electrical storage device, a magnetic storage device, an optical storage device, an electromagnetic storage device, a semiconductor storage device or any appropriate combinations of the above. More detailed examples (non-exhaustive list) of the computer readable storage medium include: a portable computer disk, a hard disk, a random-access memory (RAM), a read-only memory (ROM), an erasable programmable read-only memory (EPROM or flash memory), a static random-access memory (SRAM), a portable compact disk read-only memory (CD-ROM), a digital versatile disk (DVD), a memory stick, a floppy disk, a mechanical coding device, a punched card having stored instructions thereon, or raised structures in a groove, and any appropriate combinations of the above. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical fibers transmission, wireless transmission, routers, firewalls, switches, gateway computers and/or edge servers. A network adapter card or network interface in each computing/processing device receives computer readable program instructions from the network, and forwards the computer readable program instructions for storing in a computer readable storage medium within the respective computing/processing device.

Computer program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the case relating to the remote computer, the remote computer may be connected to the user's computer through any type of network, including a local area network (LAN) or a wide area network (WAN), or may be connected to an external computer (for example, through the Internet using an Internet Service Provider). In some embodiments, electronic circuitry, for example, programmable logic circuitry, field-programmable gate arrays (FPGA), or programmable logic arrays (PLA), which may execute computer readable program instructions, may be customized by utilizing the state information of the computer readable program instructions, in order to perform aspects of the present disclosure.

Aspects of the present disclosure are described herein with reference to flowchart illustrations and/or block diagrams of methods, apparatus (systems), and computer program products according to embodiments of the disclosure. It would be understood that each block of the flowchart illustrations and/or block diagrams, and combinations of blocks in the flowchart illustrations and/or block diagrams, can be implemented by computer readable program instructions.

These computer readable program instructions may be provided to a processing unit of a general purpose computer, special purpose computer, or other programmable data processing apparatus to produce a machine, such that the instructions, being executed by the processing unit of the computer or other programmable data processing apparatus, create an apparatus for implementing the functions/acts specified in the flowchart and/or block diagram block or blocks. These computer readable program instructions may also be stored in a computer readable storage medium, and direct a computer, a programmable data processing apparatus, and/or other devices to function in a particular manner, such that the computer readable storage medium having instructions stored therein comprises an article of manufacture including instructions which implement aspects of the functions/acts specified in the flowchart and/or block diagram block or blocks.

The computer readable program instructions may also be loaded onto a computer, other programmable data processing apparatus, or other device to cause a series of operational steps to be performed on the computer, other programmable data processing apparatus or other device to produce a computer implemented process, such that the instructions, being executed on the computer, other programmable apparatus, or other device, implement the functions/acts specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, code segment, or portion of code, which comprises one or more executable instructions for implementing the specified logical function(s). In some alternative implementations, the functions noted in the block may occur in an order different from that noted in the figures. For example, two blocks shown in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for the purpose of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or the technical improvement over technologies found in the marketplace, or to enable others of ordinary skilled in the art to understand the embodiments disclosed herein.

I/We claim:

1. A method of managing a virtual machine, comprising:
determining, based on an attribute of the virtual machine, a virtual machine client corresponding to the virtual machine, the virtual machine client being characteristic information of the virtual machine in a backup system; and
determining, based on the virtual machine client, a backup policy for the virtual machine to back up the virtual machine, the backup policy indicating a manner of backing up the virtual machine in the backup system.

2. The method of claim 1, wherein determining a virtual machine client corresponding to the virtual machine comprises:
obtaining a first predetermined rule associated with the attribute of the virtual machine; and
in response to the attribute of the virtual machine satisfying the first predetermined rule, determining the virtual machine client based on the attribute of the virtual machine.

3. The method of claim 2, wherein obtaining a first predetermined rule associated with the attribute of the virtual machine comprises:
determining, from a set of predetermined rules, a subset related to the attribute of the virtual machine; and
selecting the first predetermined rule from the subset.

4. The method of claim 2, wherein determining the virtual machine client based on the attribute of the virtual machine comprises:
including the attribute of the virtual machine in the virtual machine client.

5. The method of claim 1, wherein determining a backup policy for the virtual machine comprises:
obtaining the attribute of the virtual machine based on the virtual machine client;
obtaining a second predetermined rule associated with a predetermined backup policy; and
in response to the attribute of the virtual machine satisfying the second predetermined rule, determining the predetermined backup policy to be the backup policy for the virtual machine client.

6. The method of claim 1, further comprising:
in response to a new virtual machine being added, obtaining an attribute of the new virtual machine; and
determining, based on the attribute of the new virtual machine, a virtual machine client corresponding to the new virtual machine.

7. The method of claim 1, further comprising:
in response to the attribute of the virtual machine being changed, obtaining the changed attribute of the virtual machine; and
updating the virtual machine client based on the changed attribute of the virtual machine.

8. The method of claim 7, wherein determining the backup policy for the virtual machine comprises:
in response to the virtual machine client being updated, obtaining the attribute of the virtual machine based on the virtual machine client;
determining whether the attribute of the virtual machine satisfies a second predetermined rule associated with the backup policy for the virtual machine client; and
in response to the attribute of the virtual machine satisfying the second predetermined rule, determining the backup policy for the virtual machine.

9. The method of claim 1, wherein the attribute of the virtual machine comprises at least one of:
a name, an access path, a virtual application name, a resource pool, a data center path, a data store name, a data store cluster name, and a tag.

10. A device for managing a virtual machine, comprising:
at least one processing unit;
at least one memory, the at least one memory being coupled to the at least one processing unit and storing instructions to be executed by the at least one processing unit, the instructions, when executed by the at least one processing unit, causing the device to perform acts comprising:
determining, based on an attribute of the virtual machine, a virtual machine client corresponding to the virtual machine, the virtual machine client being characteristic information of the virtual machine in a backup system; and
determining, based on the virtual machine client, a backup policy for the virtual machine to back up the virtual machine, the backup policy indicating a manner of backing up the virtual machine in the backup system.

11. The apparatus of claim 10, wherein determining a virtual machine client corresponding to the virtual machine comprises:
obtaining a first predetermined rule associated with the attribute of the virtual machine; and
in response to the attribute of the virtual machine satisfying the first predetermined rule, determining the virtual machine client based on the attribute of the virtual machine.

12. The apparatus of claim 11, wherein obtaining a first predetermined rule associated with the attribute of the virtual machine comprises:
determining, from a set of predetermined rules, a subset related to the attribute of the virtual machine; and
selecting the first predetermined rule from the subset.

13. The apparatus of claim 11, wherein determining the virtual machine client based on the attribute of the virtual machine comprises:
including the attribute of the virtual machine in the virtual machine client.

14. The apparatus of claim 10, wherein determining a backup policy for the virtual machine comprises:
obtaining the attribute of the virtual machine based on the virtual machine client;
obtaining a second predetermined rule associated with a predetermined backup policy; and
in response to the attribute of the virtual machine satisfying the second predetermined rule, determining the predetermined backup policy to be the backup policy for the virtual machine client.

15. The apparatus of claim 10, wherein the acts further comprises:
in response to a new virtual machine being added, obtaining an attribute of the new virtual machine; and
determining, based on the attribute of the new virtual machine, a virtual machine client corresponding to the new virtual machine.

16. The apparatus of claim 10, wherein the acts further comprises:
in response to the attribute of the virtual machine being changed, obtaining the changed attribute of the virtual machine; and
updating the virtual machine client based on the changed attribute of the virtual machine.

17. The apparatus of claim 16, wherein determining the backup policy for the virtual machine comprises:
in response to the virtual machine client being updated, obtaining the attribute of the virtual machine based on the virtual machine client;
determining whether the attribute of the virtual machine satisfies a second predetermined rule associated with the backup policy for the virtual machine client; and
in response to the attribute of the virtual machine satisfying the second predetermined rule, determining the backup policy for the virtual machine.

18. The apparatus of claim 10, wherein the attribute of the virtual machine comprises at least one of:
a name, an access path, a virtual application name, a resource pool, a data center path, a data store name, a data store cluster name, and a tag.

19. A computer program product for managing a virtual machine, the computer program product comprising:
a non-transitory computer readable medium encoded with computer-executable code, the code configured to enable the execution of:
determining, based on an attribute of the virtual machine, a virtual machine client corresponding to the virtual machine, the virtual machine client being characteristic information of the virtual machine in a backup system; and
determining, based on the virtual machine client, a backup policy for the virtual machine to back up the virtual machine, the backup policy indicating a manner of backing up the virtual machine in the backup system.

20. The computer program product of claim 19, wherein determining a virtual machine client corresponding to the virtual machine comprises:
obtaining a first predetermined rule associated with the attribute of the virtual machine; and
in response to the attribute of the virtual machine satisfying the first predetermined rule, determining the virtual machine client based on the attribute of the virtual machine.
